(19) United States
(12) Patent Application Publication
(10) Pub. No.: US 2021/0367295 A1
(43) Pub. Date: Nov. 25, 2021

(54) BATTERY CELL AND BATTERY MODULE

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/324,072

(22) Filed: May 18, 2021

(30) Foreign Application Priority Data
May 25, 2020 (JP) 2020-090201

(51) Int. Cl. H01M 50/121; H01M 10/6555; H01M 10/613

(52) U.S. Cl. CPC H01M 50/121; H01M 10/613; H01M 10/6555

(57) ABSTRACT

The present disclosure is intended to provide a battery cell and a battery module including such battery cells, the battery cells being easy to fix and resistant to misalignment with respect to each other, and the battery module receiving a uniform restraining load.

A battery cell 10 includes a battery 11 and an outer sheath 12 that accommodates the battery 11 therein while being fixed to and adhering to the battery 11, the outer sheath 12 having an outermost layer L2 at least a portion of which is provided with a low melting point resin layer.

This application is based on and claims the benefit of priority from Japanese Patent Application No. 2020-090201, filed on 25 May 2020, the content of which is incorporated herein by reference.

### BACKGROUND OF THE INVENTION

### Field of the Invention

The present disclosure relates to a battery cell and a battery module.

### Related Art

In recent years, the demand for batteries with high capacity and high output has rapidly increased due to the widespread use of various types of electrical and electronic apparatuses of all sizes, such as automobiles, personal computers, and mobile telephones.

Examples of such batteries include an aqueous electrolyte battery cell including an organic electrolytic solution as an electrolyte between a positive electrode and a negative electrode, and a solid-state battery cell including a solid electrolyte as an electrolyte, instead of an organic electrolytic solution.

A laminated cell-type battery is known which is composed of a battery as described above and a laminate film (film) with which the battery is wrapped and sealed into a plate shape.

Wrapping the battery with the film makes it possible to prevent ingress of an atmosphere into the battery.
For example, a solid-state battery is disclosed which includes a laminated cell and which facilitates detection of leakage of gas from a film provided to a battery pack case (see Patent Document 1).

Patent Document 1: Japanese Unexamined Patent Application, Publication No. 2012-169204

### SUMMARY OF THE INVENTION

When a battery module is manufactured by arranging a plurality of laminated cells in layers, since the surfaces of the laminated cells are slippery, misalignment of the laminated cells has been conventionally prevented by bonding and fixing the laminated cells to each other using double-sided tape, an adhesive, or the like. However, this method is not sufficiently effective in the case of the solid-state batteries for which a uniform restraining load is particularly required. The method may allow, for example, ingress of bubbles, which can form a slight step at a position where the solid-state batteries are fixed to each other. The formation of such a step may result in a situation where a non-uniform load is applied to the solid-state batteries, giving rise to the risk of damage to electrode plates of the batteries.

In addition, the method using an adhesive or the like may cause problems, such as an increase in the number of steps of a process for assembling a module, a deterioration of volume efficiency, and egress of the liquefied adhesive or the like from between laminated cells.

The present disclosure has been achieved in view of the foregoing background, and an object of the present disclosure is to provide a battery cell and a battery module including such battery cells, the battery cells being easy to fix and resistant to misalignment with respect to each other, and the battery module receiving a uniform restraining load.

A first aspect of the present disclosure is directed to a battery cell including a battery; and an outer sheath accommodating the battery therein. The outer sheath is fixed to the battery while adhering to the battery. The outer sheath includes an outermost layer at least a portion of which is provided with a low melting point resin layer.

The first aspect of the present disclosure provides the battery cells, which are easy to fix and resistant to misalignment with respect to each other. In addition, the battery cells can form a battery module which allows a uniform restraining load to be applied.

A second aspect of the present disclosure is an embodiment of the first aspect. In the second aspect, the outer sheath having the battery accommodated therein has a first side surface and a second side surface that faces the first side surface. The first side surface has an outermost layer provided with a low melting point resin layer, and the second side surface has an outermost layer provided with a low melting point resin layer.

The second aspect of the present disclosure provides the plurality of battery cells, which can be easily fixed after having been arranged in layers and definitely positioned, and which can form a battery module which allows a uniform restraining load to be applied.

A third aspect of the present disclosure is an embodiment of the first or second aspect. In the third aspect, the outer sheath is made of one film, and includes a bent portion formed by bending the one film such that the battery is accommodated and joining portions constituted by opposite end portions of the one film that are joined to each other.

According to the third aspect, the area of the joining portions of the outer sheath can be reduced, thereby enabling an effective increase in a volume energy density of the battery cell.

A fourth aspect of the present disclosure is an embodiment of the third aspect. In the fourth aspect, the outer sheath having the battery accommodated therein has an overlapping region where a portion of the outer sheath overlaps with an other portion of the outer sheath. In the overlapping region, a low melting point resin layer is provided on an outermost layer of at least an inward positioned portion of the portion, the inward positioned portion being positioned inward relative to the other portion.

The fourth aspect of the present disclosure provides the battery cell with the outer sheath having the portions further firmly joined to each other.

A fifth aspect of the present disclosure is an embodiment of any one of the first to fourth aspects. In the fifth aspect, a low melting point resin forming the low melting point resin layer has a melting point of 80° C. or higher and 260° C. or lower.

According to the fifth aspect of the present disclosure, the battery cells can be more satisfactorily fixed to each other. The fifth aspect provides the battery cells, which can form a battery module which allows a uniform restraining load to be applied.

A sixth aspect of the present disclosure is an embodiment of any one of the first to fifth aspects. In the sixth aspect, the low melting point resin layer has a melting point that varies from location to location on the outer sheath.

The sixth aspect of the present disclosure can enhance efficiency in manufacture of the battery cells and manufacture of the battery module.

A seventh aspect of the present disclosure is an embodiment of any one of the first to sixth aspects. In the seventh aspect, the battery is a solid-state battery.

The seventh aspect of the present disclosure makes it possible to apply a uniform restraining load to the solid-state battery of which the electrode plates are susceptible to damage, thereby making it less likely for the electrode plates of the solid-state battery to become damaged.

An eighth aspect of the present disclosure is directed to a battery module including the battery cell according to any one of the first to seventh aspects, the battery cell including a plurality of battery cells arranged in layers. The plurality of battery cells have side surfaces adjacent to each other, and the low melting point resin layer is provided on each of portions of the outermost layer of the outer sheath, the portions corresponding to the side surfaces.

The eighth aspect of the present disclosure makes it possible to arrange and uniformly fix the plurality of battery cells in layers, and can improve volumetric efficiency of the battery module.

A ninth aspect of the present disclosure is an embodiment of the eighth aspect. In the ninth aspect, the battery module further includes a thermally conductive member disposed between the plurality of battery cells.

According to the ninth aspect of the present disclosure, after the plurality of battery cells are arranged in layers and definitely positioned, the plurality of battery cells can be fixed easily and uniformly.

### BRIEF DESCRIPTION OF THE DRAWINGS

FIG. 1 is a perspective view illustrating a battery cell 10 according to an embodiment;

FIG. 2 is a cross-sectional view taken along line A-A in FIG. 1;

FIG. 3 is a cross-sectional view schematically illustrating a structure of an outer sheath 12 according to an embodiment;

FIG. 4 is a development of the outer sheath 12 according to the embodiment;

FIG. 5 is a development of the outer sheath 12 according to the embodiment;

FIG. 6A is a perspective view illustrating, as an example, a step in a method of manufacturing a battery cell including the outer sheath 12 according to the embodiment;

FIG. 6B is a perspective view illustrating, as an example, a step of the method of manufacturing the battery cell including the outer sheath 12 according to the embodiment;

FIG. 6C is a perspective view illustrating, as an example, a step of the method of manufacturing the battery cell including the outer sheath 12 according to the embodiment;

FIG. 6D is a perspective view illustrating, as an example, a step of the method of manufacturing the battery cell including the outer sheath 12 according to the embodiment;

FIG. 7 is a perspective view illustrating a battery module 1 according to an embodiment; and

FIG. 8 is a cross-sectional view taken along line B-B in FIG. 7.

### DETAILED DESCRIPTION OF THE INVENTION

Embodiments of the present disclosure will be described with reference to the drawings.

It should be noted that the following embodiments are non-limiting examples, and are not intended to limit the present disclosure.

### <Battery Cell>

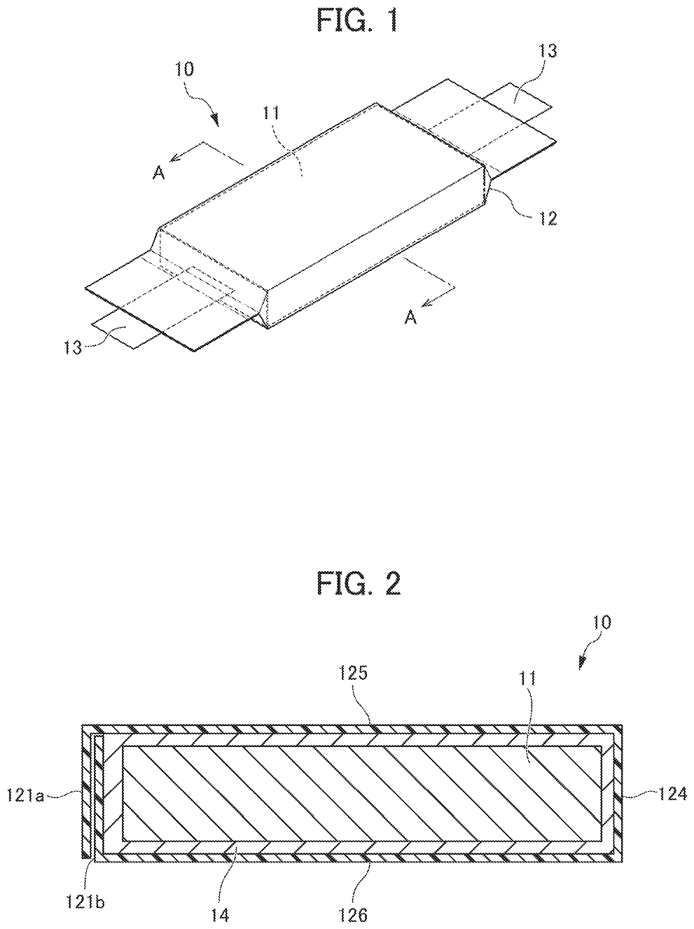

As illustrated in FIG. 1, a battery cell 10 includes a battery 11, an outer sheath 12, and collector tabs 13.

The battery 11 is accommodated in the outer sheath 12. The collector tabs 13 that constitute electrodes of the battery cell 10 extend outward from one side surface and another side surface of the battery 11.
A conventional laminate film includes a low melting point resin layer on the innermost layer thereof. Portions of the innermost layer are fusion-bonded to each other by application of heat, whereby the battery or the like is accommodated.
The outer sheath 12 according to the present embodiment is configured to enclose the battery 11 having a substantially rectangular parallelepiped shape, and includes an outermost layer at least a portion of which is provided with a low melting point resin layer.
This configuration makes it possible to arrange a plurality of battery cells 10 in layers and to fix the plurality of battery cells 10 to each the other by way of fusion-bonding the low melting point resin layers provided on the outermost layers of the outer sheaths 12.
Thus, the plurality of battery cells 10 can be easily arranged in layers substantially without misalignment.
Note that “battery” as used herein refers to a layered structure to be described later, the layered structure excluding the outer sheath, but having collector tab leads connected thereto.
On the other hand, “battery cell” refers to a structure including the “battery” and the outer sheath.

### (Battery)

The battery 11 includes a negative electrode having a negative electrode collector, a solid electrolyte, and a positive electrode having a positive electrode collector.

The battery 11 may be an aqueous electrolyte battery including an organic electrolytic solution as the electrolyte, a battery including a gel electrolyte, or a solid-state battery including a flame-retardant solid electrolyte as the electrolyte, instead of an organic electrolytic solution.
Since the battery cells 10 according to the present embodiment can be arranged in layers while receiving a uniform restraining pressure, the battery 11 is preferably a solid-state battery.
The following description is based on the assumption that the battery 11 is a solid-state battery.

The negative electrode includes the negative electrode collector and a negative electrode layer formed on a surface of the negative electrode collector.

The positive electrode includes the positive electrode collector and a positive electrode layer formed on the positive electrode collector.

The negative electrode collector is not particularly limited, as long as it has a function of collecting an electrical current from the negative electrode layer.

Examples of a material for the negative electrode collector include nickel, copper, and stainless steel.
Examples of a shape of the negative electrode collector include a foil shape, a plate shape, a mesh shape, and a foam shape, among which the foil shape is preferable.

The negative electrode layer is a layer containing at least a negative electrode active material.

As the negative electrode active material, a material capable of occluding and emitting ions (e.g., lithium ions) can be appropriately selected for use.
Specific examples of the negative electrode active material include: lithium transition metal oxides such as lithium titanate (Li₄Ti₅O₁₂); transition metal oxides such as TiO₂, Nb₂O₃, and WO₃; metal sulfides; metal nitrides; carbon materials such as graphite, soft carbon, and hard carbon; metal lithium; metal indium; and lithium alloys.
The negative electrode active material may be powdered or formed into a thin film.

The positive electrode collector is not particularly limited, as long as it has a function of collecting an electrical current from the positive electrode layer.

Examples of a material for the positive electrode collector include aluminum, aluminum alloys, stainless steel, nickel, iron, and titanium.
Among the examples, aluminum, aluminum alloys, and stainless steel are preferable.
Examples of a shape of the positive electrode collector include a foil shape, a plate shape, a mesh shape, and a foam shape, among which the foil shape is preferable.

The positive electrode layer is a layer containing at least a positive electrode active material.

As the positive electrode active material, a material capable of occluding and emitting ions (e.g., lithium ions) can be appropriately selected for use.
Specific examples of the positive electrode active material include: lithium cobaltate (LiCoO₂); lithium nickelate (LiNiO₂); LiNiₚMn_{g}CoᵣO₂ (where p+q+r=1); LiNiₚAl_{q}CoᵣO₂ (where p+q+r=1); lithium manganate (LiMn₂O₄); different kind element substituent Li—Mn spinel described as L₁₊ₓMn_{2-x-y}M_{y}O₄ (where x+y=2, and M is at least one selected from Al, Mg, Co, Fe, Ni, and Zn); and lithium metal phosphate (LiMPO₄, where M is at least one selected from Fe, Mn, Co, and Ni).

The solid electrolyte is disposed between the positive electrode and the negative electrode, and contains at least a solid electrolyte material.

The solid electrolyte is provided as, for example, a solid electrolyte layer.
Ions (e.g., lithium ions) can be conducted between the positive electrode active material and the negative electrode active material, via the solid electrolyte material contained in the solid electrolyte layer.

### (Outer Sheath)

The outer sheath 12 accommodates the battery 11 while being fixed and adhering to the battery 11.

The outer sheath 12 hermetically accommodates the battery 11, thereby enabling prevention of ingress of an atmosphere into the battery 11.

As illustrated in FIG. 2, the outer sheath 12 is made of one film configured to accommodate the battery 11 having a substantially rectangular parallelepiped shape. The outer sheath 12 has a bent portion 124 where the one film is bent along one end surface of the battery 11, and a joining portion 121a and a joining portion 121b that are constituted by opposite end portions of the one film, the opposite end portions being joined to each other.

The outer sheath 12 further has a first side surface 125 and a second side surface 126 that face each other.
A support member 14 for protecting the battery 11 against an external impact may be provided between the outer sheath 12 and the battery 11.

The outer sheath 12 is made of the film, and has the outermost layer at least a portion of which is provided with a low melting point resin layer.

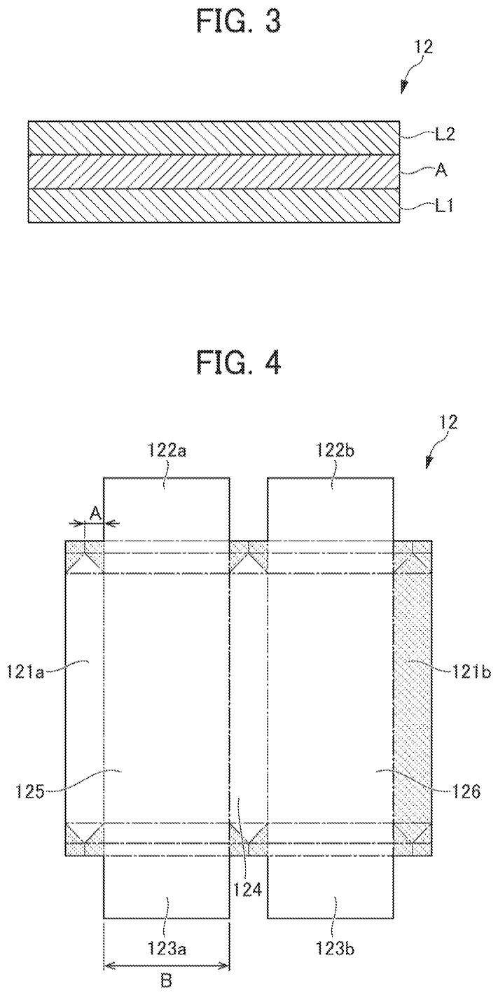

FIG. 3 is a cross-sectional view schematically illustrating the structure of the film according to the present embodiment.
The outer sheath 12 includes a plurality of layers, such as an innermost layer L1, a barrier layer A, and the outermost layer L2.

The barrier layer A consists of, for example, an inorganic thin film such as aluminum foil, or a thin film of an inorganic oxide, such as a silicon oxide or an aluminum oxide.

Inclusion of the barrier layer A in the film can impart airtightness to the outer sheath 12.

The innermost layer L1 is provided with a seal layer that is a low melting point resin layer.

The provision of the low melting point resin layer to the innermost layer L1 of the outer sheath 12 makes it possible to join by welding the opposite surfaces of the outer sheath 12 to each other.
This feature eliminates the need for a step of applying an adhesive for joining portions of the outer sheath 12.
Note that the seal layer may be omitted from the innermost layer L1 of the outer sheath 12, and the outer sheath 12 may be joined using an adhesive.

The outermost layer L2 is provided with a seal layer as a low melting point resin layer that is the same or similar to the seal layer of the innermost layer L1.

The provision of the low melting point resin layer to the outermost layer L2 of the outer sheath 12 makes it possible to arrange the plurality of battery cells 10 in layers, and to uniformly join by welding the outermost layers L2 of adjacent ones of the battery cells 10 to each other.
This feature enables a uniform restraining pressure to be applied to the laminated cells.
In addition, since the step of applying an adhesive or the like is no longer necessary, misalignment of the plurality of battery cells 10 can be prevented when the plurality of battery cells 10 are arranged in layers.
Further, in comparison with a case of using an adhesive or the like, ingress of bubbles is less likely to occur, and consequently, the likelihood of formation of a step is reduced when the battery cells 10 are joined. This feature makes it possible to uniformly arrange and fix the plurality of battery cells 10 in layers.

A low melting point resin forming the low melting point resin layer of the innermost layer LU and a low melting point resin forming the low melting point resin layer of the outermost layer L2 are each preferably a thermoplastic resin having a melting point from 80° C. to 260° C.

The thermoplastic resin is not limited to any specific resin. Known thermoplastic resins for use as a seal layer of a wrapping film can be used appropriately. Examples of such resins include ethylene resins such as polyethylene, propylene resins such as polypropylene, and copolymer resins of an ethylene resin and a different resin, such as ethylene-methyl methacrylate copolymer (EMMA).
The thermoplastic resin is melted and welded when heated, and then, is solidified and fixed when cooled.
The melting point of the low melting point resin is more preferably 100° C. to 150° C.

The outer sheath 12 may include a further layer other than those described above.

For example, a substrate layer, which is made of, for example, polyethylene terephthalate, polyethylene naphthalate, nylon, or polypropylene, may be provided between the barrier layer A and the outermost layer L2 or between the barrier layer A and the innermost layer L1.

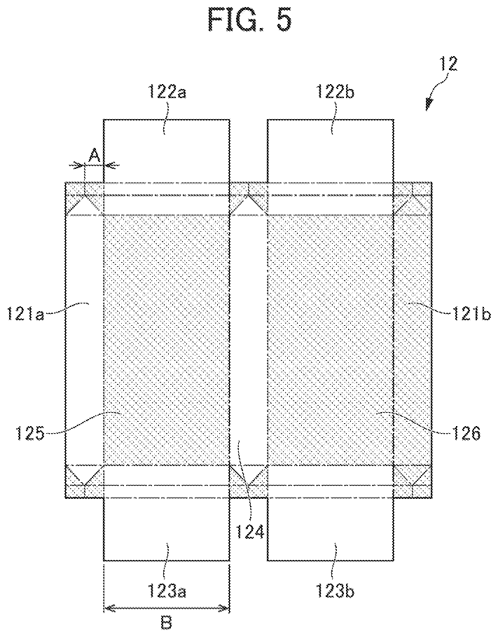

As illustrated in FIGS. 4 and 5, the outer sheath 12 has joining portions that are positioned to face each other and joined together in a state where the outer sheath 12 has the battery 11 accommodated therein. Specifically, the joining portions include pairwise joining portion 121a and 121b, pairwise joining portions 122a and 122b, and pairwise joining portions 123a and 123b.

Further, the outer sheath 12 has the first side surface 125 and the second side surface 126.
In the state where the outer sheath 12 has the battery 11 accommodated therein, the first side surface 125 is positioned to face the second side surface 126.
It is preferable that a length A and a length B shown in FIGS. 4 and 5 have a relationship described as A>B/2.

The low melting point resin layer may be formed over the entire outermost layer L2 of the outer sheath 12, or on a portion of the outermost layer L2.

The low melting point resin layer on the outermost layer L2 of the outer sheath 12 may be provided on at least a portion of the first side surface 125 and at least a portion of the second side surface 126 of the outer sheath 12 having the battery 11 accommodated therein. This configuration makes it possible to easily arrange and fix the battery cells 10 in layers, without having to use an adhesive or the like.

The low melting point resin layer may be formed on, for example, portions of the outermost layer L2 of the outer sheath 12, the portions being marked with hatching in FIG. 4.

In a state where the outer sheath 12 has the battery 11 accommodated therein, the portions with hatching are to overlap with other portions of the outer sheath 12 and are to be positioned inward relative to the other portions.
Accordingly, in such overlapping regions where the portions of the outer sheath 12 overlap with each other, the low melting point resin layer of the outermost layer L2 and the low melting point layer of the innermost layer L1 are fusion-bonded to each other, thereby achieving the battery cell 10 with the outer sheath 12 having the portions firmly joined to each other.

Preferably, the low melting point resin layer is formed on, for example, portions of the outermost layer L2 of the outer sheath 12, the portions being marked with hatching in FIG. 5.

The portions marked with the hatching in FIG. 5 include, in addition to the portions with the hatching in FIG. 4, the first side surface 125 and the second side surface 126 of the outer sheath 12 having the battery 11 accommodated therein.
When the plurality of battery cells 10 are arranged such that the first and second side surfaces 125 and 126 are adjacent to each other, this configuration makes it possible to easily arrange and fix the plurality of battery cells 10 in layers, without having to use an adhesive or the like.
The low melting point resin layer is formed over the entire outermost layer of the first side surface 125 and the entire outermost layer of the second side surface 126. This configuration makes it possible to uniformly fix the plurality of battery cells 10 without allowing formation of any slight step, unlike the case of using an adhesive or the like to fix the battery cells 10.
As a result, a further uniform restraining load can be applied to the plurality of battery cells 10 arranged in layers.

The outermost layer L2 and the innermost layer L1 of the outer sheath 12 may have the same melting temperature (temperature at which the respective layers begin to melt) or different melting temperatures. The melting temperature of the outermost layer L2 and the melting temperature of the innermost layer L1 may each vary from location to location.

It is preferable to selectively set the melting temperatures according to a manufacturing process of the battery cell 10 and a manufacturing process of a battery module 1.
For example, the melting temperature of portions to be joined earlier, such as the portions to be joined when the battery 11 is wrapped with the outer sheath 12, may be set lower than the melting temperature of other portions to be joined later, such as portions to be joined when the plurality of battery cells 10 are arranged in layers. This setting of the melting temperatures facilitates manufacture of the battery cells 10 and the battery module 1.

Preferably, the joining portions 122a and 122b are joined to each other while holding one of the collector tabs 13 therebetween and the joining portions 123a and 123b are joined to each other while holding the other collector tab 13 therebetween.

This configuration reduces the area of the joining portions of the outer sheath 12, i.e., the portions of the outer sheath 12 that are joined to each other, and accordingly, can reduce formation of dead spaces, thereby contributing to effective improvement of a volume energy density of the battery module 1.

Although a preferred thickness of the outer sheath 12 differs depending on the type of the material forming the outer sheath 12, the thickness is preferably 50 μm or greater, and more preferably 100 μm or greater.

The thickness of the outer sheath 12 is preferably 700 μm or less, and more preferably 200 μm or less.

The collector tabs 13 are formed by extending a portion of the negative electrode collector of the battery 11 and a portion of the positive electrode collector of the battery 11 outward from one end face and another end face of the battery 11.

In the present embodiment, it is only necessary for the collector tabs 13 to extend outward from the respective collectors.
In other words, each of the collector tabs 13 may be an extended portion of the associated collector, or may be formed as a member different from the collector.
Materials for use as the collector tabs 13 are not particularly limited. It is possible to use a material that is the same or similar to those used in conventional solid-state batteries.

### <Method of Manufacturing Battery Cell 10>

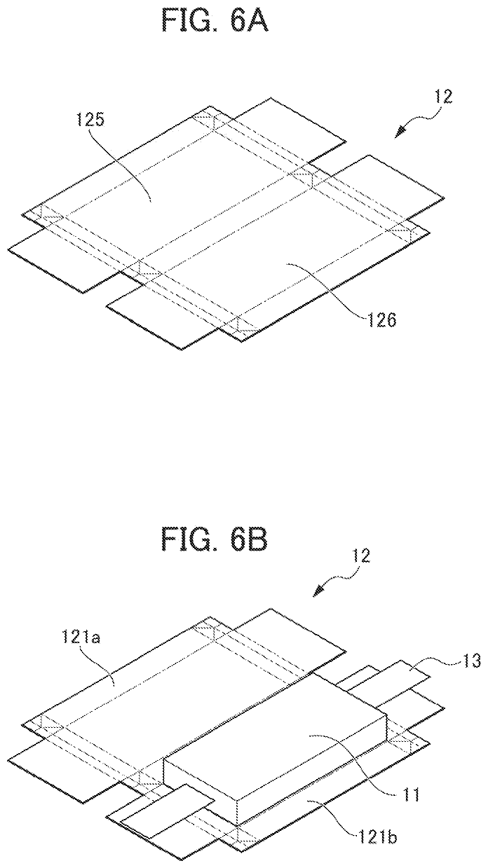

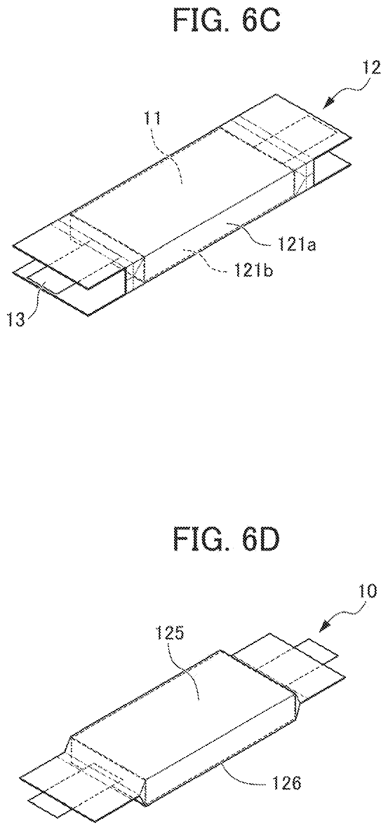

A method of manufacturing the battery cell 10 includes, for example, steps illustrated in FIGS. 6A to 60. Specifically, the method includes: a step in FIG. 6A, including producing the outer sheath 12; a step in FIG. 6B, including placing the battery 11 on the outer sheath 12; a step in FIG. 6C, including bending the outer sheath 12 into a cylindrical shape and joining portions of the outer sheath 12; and a step in FIG. 6D, including sealing the outer sheath 12 by welding other joining portions of the outer sheath 12.

FIG. 6A: In the step of producing the outer sheath 12, the outer sheath 12 as one film is produced while having bend lines and the like formed thereon in advance.

The bend lines and the like are formed according to the shape and size of the battery 11 to be accommodated in the outer sheath 12.

FIG. 6B: In the step of placing the battery 11 on the outer sheath 12, the battery 11 is placed on the outer sheath 12 such that the battery 11 is positioned along the bend lines on the outer sheath 12.

FIG. 6C: In the step of bending the outer sheath 12 into a cylindrical shape, the outer sheath 12 is bent into a cylindrical shape such that the battery 11 is accommodated in the outer sheath 12, and the joining portions 121a and 121b are joined by welding to each other by external application of heat.

For example, provision of a low melting point resin layer on the outermost layer of the joining portion 121b, which is positioned inward when joined to the joining portion 121a, makes it possible to firmly join the joining portions 121a and 121b to each other.

FIG. 6D: In the step of sealing the outer sheath 12 by welding the other joining portions of the outer sheath 12, the joining portions 122a and 122b are joined to each other while holding the collector tab 13 therebetween, and the joining portions 123a and 123b are joined to each other while holding the other collector tab 13 therebetween.

This feature reduces the area of the joining portions of the outer sheath 12 constituted by the portions of the outer sheath 12 that are joined to each other, and accordingly, reduces formation of dead spaces, thereby contributing to effective improvement of a volume energy density of the battery cell 10.

If the battery 11 is a solid-state battery, it is preferable to evacuate the interior of the outer sheath 12 before the step illustrated in FIG. 6D.

The evacuation allows atmospheric pressure to be uniformly applied to the battery cell including the end face where the bent portion 124 is formed, thereby enabling the sold-state battery to be fixed further firmly.
The evacuation also makes it less likely for the layered structure of the solid-state battery to become misaligned due to vibration, and for the electrodes to become cracked or broken, thereby increasing the durability.

Note that the placement of the battery 11 on the outer sheath 12 may be preceded by the step illustrated in FIG. 6C, in which the outer sheath 12 is bent into a cylindrical shape and the portions of the outer sheath 12 are joined. In this case, the battery 11 is inserted into the cylindrical outer sheath 12.

Nevertheless, the above-described process, according to which the battery 11 is placed on the outer sheath 12 having the bend lines formed thereon, and then, the joining portions are joined to each other, enables the battery to be accommodated while further reducing or eliminating gaps.
Thus, the above-described process makes it possible to effectively increase the volume energy density of the battery cell 10.

### <Battery Module>

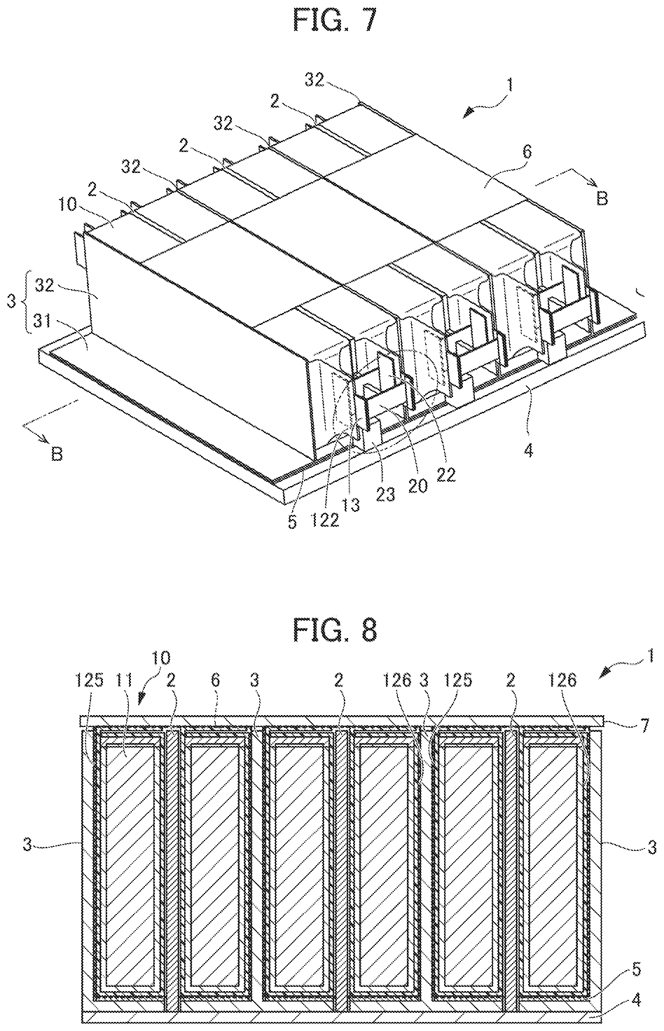

As illustrated in FIG. 7, the battery module 1 includes a plurality of battery cells 10, structural members 2, cooling plates 3, a placement board 4, vibration-isolating members 5, and a fastening film 6.

The battery module 1 is formed by arranging the plurality of battery cells 10 in layers and electrically connecting the plurality of battery cells 10 to each other.

The collector tabs 13 that form the electrodes extend outward from the plurality of battery cells 10.

Adjacent ones of the collector tabs 13 are surface-supported by collector tab supports 22 that form part of the structural member 2, and are electrically connected to each other via a busbar 20.
The plurality of battery cells 10 are connected in series or parallel to each other.

FIG. 8 is a cross-sectional view taken along line B-B in FIG. 7. As illustrated in FIG. 8, the plurality of battery cells 10 are arranged such that the first side surface 125 and the second side surface 126 are adjacent to each other, the first and second side surfaces 125 and 126 each having the outermost layer provided with the low melting point resin layer.

In the present embodiment, the structural members 2 are each arranged between adjacent ones of the plurality of battery cells 10.
Since the plurality of battery cells 10 are joined to each other by means of the low melting point resin layers, the volume energy density of the battery module 1 can be effectively improved, in comparison with the case of using an adhesive or the like.
Although omitted from FIG. 7, a top cover 7 is provided to cover the upper surface of the battery module 1, as illustrated in FIG. 8.

The structural members 2, which are each held between adjacent ones of the battery cells 10, surface-support the battery cells 10, and are configured to prevent damage to the battery cells 10.

The structural member 2 is preferably a thermally conductive member having a high thermal conductivity, such as a metal member.
This configuration makes it possible to efficiently dissipate heat generated by the battery cells 10.
In the process of manufacturing the battery module 1, the plurality of battery cells 10 are arranged in layers on the placement board 4 while having the thermally conductive members disposed therebetween, and thereafter, the thermally conductive members are heated, whereby the plurality of battery cells 10 can be easily fixed.
Specifically, the low melting point resin layers provided on the outermost layers of the first and second side surfaces 125 and 126 are melted by the heated thermally conductive members melt, and then, fusion-bonded to the thermally conductive members.
Thereafter, the thermally conductive members are cooled to solidify the low melting point resin layers, thereby enabling the plurality of battery cells 10 to be fixed.
This process makes it possible to fix, substantially without misalignment, the plurality of battery cells 10 that have been definitively positioned.

The structural member 2 includes the busbar 20, the collector tab supports 22, and structural member fasteners 23.

The structural member 2 may further include, in an upper portion or any other portion thereof, a heatsink having a comb shape or a sawtooth shape, or a heatsink formed as through holes.
The heatsink increases a surface area of the structural member 2, thereby enabling effective dissipation of heat generated by the battery cells 10.

The busbar 20 surface-supports the collector tabs 13 or collector tab leads electrically connected to the collector tabs 13, and establishes electrical connection between the collector tabs 13 or the collector tab leads of adjacent ones of the battery cells 10.

The collector tab support 22 is configured to surface-support the collector tab 13 or the collector tab lead via the outer sheath 12. This configuration can further effectively prevent damage to the battery cells 10, and makes it possible to gather, to the busbars 20, the electricity generated by the plurality of battery cells 10 connected to each other.
The structural member fasteners 23 are disposed on opposite sides of a lower portion of the structural member 2, and fasten the structural member 2 to the placement board 4.
The structural member fasteners 23 allow the battery cells 10 to be effectively fixed, thereby further effectively preventing damage to the battery cells 10.

The cooling plates 3 dissipate heat generated by the battery cells 10, by being in contact with battery cells 10.

The cooling plate 3 includes, for example, a battery cell placement portion 31 on which placement surfaces of the battery cells 10 are placed, and a battery cell interposition portion 32 that extends upward from the battery cell placement portion 31 and is interposed between the battery cells 10.
The cooling plates 3 may be additionally positioned on, for example, the placement surfaces of the battery cells 10 and between adjacent ones of the battery cells 10.

A material forming the cooling plate 3 is not particularly limited, but is preferably a material having a high thermal conductivity, such as a metal.

In the process of manufacturing the battery module 1, the plurality of battery cells 10 arranged in layers may be sandwiched between the cooling plates 3, and the cooling plates 3 may be heated to fusion-bond the low melting point resin layers on the outermost layers of the first and second side surfaces 125 and 126 of the battery cells 10 that are adjacent to the cooling plates 3. Thereafter, the cooling plates 3 may be cooled. In this way, the plurality of battery cells 10 can be fixed.
The thermal conductivity of the material forming the cooling plate 3 is preferably 5 W/(m·K) or greater, more preferably 20 W/(m·K) or greater, and further more preferably 50 W/(m·K) or greater.

The placement board 4 receives the plurality of battery cells 10 placed thereover.

Although a material forming the placement board 4 is not particularly limited, it is preferable to use a material having a high thermal conductivity, such as a metal.
Forming the placement board 4 using such a material can effectively prevent damage to the battery cells 10, and can effectively dissipate heat generated by the battery cells 10.
The thermal conductivity of the material forming the placement board 4 is preferably 5 W/(m·K) or greater, more preferably 20 W/(m·K) or greater, and further more preferably 50 W/(m-K) or greater.

The vibration-insulating members 5 receive the plurality of battery cells 10 placed thereon.

In the present embodiment, the vibration-insulating member 5 is placed on the upper surface of the cooling plate 3 for each of the plurality of battery cells 10.
The plurality of battery cells 10 may be placed over the upper surface of the placement board 4 via the vibration-insulating members 5.
Placing the plurality of battery cells 10 via the vibration-insulating members 5 can effectively reduce vibration of the battery cells 10.
A material forming the vibration-insulating member 5 is selected from known vibration-insulating materials, such as urethane rubber and silicone rubber.

The fastening film 6 fastens the plurality of battery cells 10. The fastening film 6 can effectively prevent damage to the battery cells 10.

The fastening film 6 may be made of any material, examples of which include adhesive tapes made of paper, fabric, films (cellophane, OPP, acetate, polyimide, PVC, etc.), and metal foil.

The top cover 7 covers the upper surface of the battery module 1 and is equivalent to a lid of the battery module 1.

The top cover 7 ensures electric insulation for the battery module 1.

In the foregoing, a preferred embodiment of the present disclosure has been described. However, the above-described embodiment is not intended to limit the present disclosure. The scope of the present disclosure further encompasses appropriate modifications that are made without impeding the present disclosure from exerting the effects.

In the above-described embodiment, the outer sheath 12 is formed by bending one film.

However, this is a non-limiting example.
The outer sheath 12 may be composed of two films. In this case, the battery is wrapped with the two films facing each other, and four sides as joining portions of one of the films are joined to four sides as joining portions of the other so that the battery is hermetically sealed.

In the above-described embodiment, the battery module 1 includes the plurality of battery cells 10 and the structural members 2 provided between the battery cells 10.

However, this is a non-limiting example.
The plurality of battery cells 10 may be directly joined and fixed to each other, without interposition of the structural embers 2.

In the above-described embodiment, the structural member 2 is preferably a thermally conductive member, and the thermally conductive member is heated so that the low melting point resin layers provided on the outermost layers of the first and second side surfaces 125 and 126 can be fusion-bonded.

However, this is a non-limiting example.
In a case where the battery module 1 is not provided with the structural members 2, the battery module 1 including the plurality of battery cells 10 arranged in layers is heated in an oven or the like, and thereafter, the battery module 1 is cooled. In this way, the low melting point resin layers provided on the outermost layers of the side surfaces of adjacent ones of the plurality of battery cells 10 are fusion-bonded, thereby enabling the plurality of battery cells 10 to be fixed.
In a case where the battery cells 10 are solid-state batteries that are free of a combustible electrolytic solution, this method also enables the battery cells 10 to be fixed substantially without misalignment.

### EXPLANATION OF REFERENCE NUMERALS

1: Battery Module
2: Structural Member (Thermally Conductive Member)
10: Battery Cell
11: Battery
12: Outer Sheath
124: Bent Portion
125: First Side Surface
126: Second Side Surface
121a, 121b, 122a, 122b, 123a, 123b: Joining Portion
L2: Outermost Layer

What is claimed is:

1. A battery cell comprising:
a battery; and
an outer sheath accommodating the battery therein,
wherein the outer sheath is fixed to the battery while adhering to the battery, and
wherein the outer sheath includes an outermost layer at least a portion of which is provided with a low melting point resin layer.

2. The battery cell according to claim 1,
wherein the outer sheath having the battery accommodated therein has a first side surface and a second side surface that faces the first side surface,
wherein the first side surface has an outermost layer provided with a low melting point resin layer, and
wherein the second side surface has an outermost layer provided with a low melting point resin layer.

3. The battery cell according to claim 1,
wherein the outer sheath is made of one film, and includes a bent portion formed by bending the one film such that the battery is accommodated, and joining portions constituted by opposite end portions of the one film that are joined to each other.

4. The battery cell according to claim 3,
wherein the outer sheath having the battery accommodated therein has an overlapping region where a portion of the outer sheath overlaps with an other portion of the outer sheath, and
wherein in the overlapping region, a low melting point resin layer is provided on an outermost layer of at least an inward positioned portion of the portion, the inward positioned portion being positioned inward relative to the other portion.

5. The battery cell according to claim 1,
wherein a low melting point resin forming the low melting point resin layer has a melting point of 80° C. or higher and 260° C. or lower.

6. The battery cell according to claim 1,
wherein the low melting point resin layer has a melting point that differs from location to location on the outer sheath.

7. The battery cell according to claim 1,
wherein the battery is a solid-state battery.

8. A battery module comprising:
the battery cell according to claim 1, the battery cell comprising a plurality of battery cells arranged in layers,
wherein the plurality of battery cells have side surfaces adjacent to each other, and
wherein the low melting point resin layer is provided on each of portions of the outermost layer of the outer sheath, the portions corresponding to the side surfaces.

9. The battery module according to claim 8, further comprising:
a thermally conductive member disposed between the plurality of battery cells.
